(19) United States
(12) Patent Application Publication
(10) Pub. No.: US 2014/0116690 A1
(43) Pub. Date: May 1, 2014

(54) PROCESS FOR MINERAL OIL PRODUCTION USING SURFACTANTS AT LEAST COMPRISING A SECONDARY ALKANESULFONATE AS A COSURFACTANT

(71) Applicant: BASF SE, Ludwigshafen (DE)

(72) Inventors: Christian Bittner, Bensheim (DE); Günter Oetter, Frankenthal (DE); Jack Tinsley, Houston, TX (US); Christian Spindler, Houston, TX (US); Gabriela Alvarez-Juergenson, Mannheim (DE); Sophie Maitro-Vogel, Mannheim (DE)

(73) Assignee: BASF SE, Ludwigshafen (DE)

(21) Appl. No.: 14/063,013

(22) Filed: Oct. 25, 2013

Related U.S. Application Data
(60) Provisional application No. 61/718,747, filed on Oct. 26, 2012.

(51) Int. Cl. E21B 43/16; C09K 8/584

(52) U.S. Cl. CPC E21B 43/16; C09K 8/584
USPC 166/270.1; 507/259

(57) ABSTRACT

The present invention relates to a surfactant mixture comprising at least one secondary alkanesulfonate having 14 to 17 carbon atoms of the general formula (I)

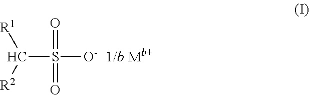

and at least one anionic surfactant of the general formula (II)

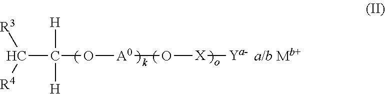

where R¹, R², R³, R⁴, A⁰, k, X, o, Y, a, b, M are each as defined in the description and the claims. The invention further relates to the use and production thereof, and to aqueous surfactant formulations comprising the surfactant mixture, and to processes for producing mineral oil by means of Winsor type III microemulsion flooding, in which the aqueous surfactant formulation is injected through injection wells into a mineral oil deposit and crude oil is withdrawn through production wells from the deposit.

The present invention relates to a surfactant mixture, to the use and production thereof, and to aqueous surfactant formulations comprising the surfactant mixture, and to processes for producing mineral oil by means of Winsor type III microemulsion flooding, in which the aqueous surfactant formulation is injected through injection wells into a mineral oil deposit and crude oil is withdrawn through production wells from the deposit.

In natural mineral oil deposits, mineral oil is present in the cavities of porous reservoir rocks which are sealed toward the surface of the earth by impervious top layers. The cavities may be very fine cavities, capillaries, pores or the like. Fine pore necks may have, for example, a diameter of only about 1 μm. As well as mineral oil, including fractions of natural gas, a deposit comprises water with a greater or lesser salt content.

In mineral oil production, a distinction is generally made between primary, secondary and tertiary production. In primary production, after commencement of drilling of the deposit, the mineral oil flows of its own accord through the borehole to the surface owing to the autogenous pressure of the deposit.

After primary production, secondary production is used. In secondary production, in addition to the boreholes which serve for the production of the mineral oil, called the production wells, further boreholes are drilled into the mineral oil-bearing formation. Water is injected into the deposit through these so-called injection wells in order to maintain the pressure or to increase it again. As a result of the injection of the water, the mineral oil is forced gradually through the cavities into the formation, proceeding from the injection well in the direction of the production well. However, this only works for as long as the cavities are completely filled with oil and the more viscous oil is pushed onward by the water. As soon as the mobile water breaks through cavities, it flows on the path of least resistance from this time, i.e. through the channel formed, and no longer pushes the oil onward.

By means of primary and secondary production, generally only approx. 30 to 35% of the amount of mineral oil present in the deposit can be produced.

It is known that the mineral oil yield can be enhanced further by measures for tertiary oil production. An overview of tertiary oil production can be found, for example, in “Journal of Petroleum Science of Engineering 19 (1998)”, pages 265 to 280. Tertiary oil production includes thermal processes in which hot water or steam is injected into the deposit. This lowers the viscosity of the oil. The flooding media used may likewise be gases such as CO₂ or nitrogen.

Tertiary mineral oil production also includes methods in which suitable chemicals are used as assistants for oil production. These can be used to influence the situation toward the end of water flooding and as a result also to produce mineral oil hitherto held firmly within the rock formation.

Viscous and capillary forces act on the mineral oil which is trapped in the pores of the deposit rock toward the end of the secondary production, the ratio of these two forces relative to one another determining the microscopic oil removal. A dimensionless parameter, called the capillary number, is used to describe the action of these forces. It is the ratio of the viscosity forces (velocity x viscosity of the forcing phase) to the capillary forces (interfacial tension between oil and water x wetting of the rock):

$${N}_{c} = \frac{μ v}{σ cos θ} .$$

In this formula, μ is the viscosity of the mineral oil-mobilizing fluid, ν is the Darcy velocity (flow per unit area), σ is the interfacial tension between mineral oil-mobilizing liquid and mineral oil, and θ is the contact angle between mineral oil and the rock (C. Melrose, C. F. Brandner, J. Canadian Petr. Techn. 58, October-December, 1974). The higher the capillary number, the greater the mobilization of the oil and hence also the degree of oil removal.

It is known that the capillary number toward the end of secondary mineral oil production is in the region of about 10⁻⁶ and that it is necessary to increase the capillary number to about 10⁻³ to 10⁻² in order to be able to mobilize additional mineral oil.

For this purpose, it is possible to conduct a particular form of the flooding method—what is known as Winsor type III microemulsion flooding. In Winsor type III microemulsion flooding, the injected surfactants are supposed to form a Winsor type III microemulsion with the water phase and oil phase present in the deposit. A Winsor type III microemulsion is not an emulsion with particularly small droplets, but rather a thermodynamically stable, liquid mixture of water, oil and surfactants. The three advantages thereof are that
a very low interfacial tension σ between mineral oil and aqueous phase is thus achieved,
it generally has a very low viscosity and as a result is not trapped in a porous matrix,
it forms with even the smallest energy inputs and can remain stable over an infinitely long period (conventional emulsions, in contrast, require high shear forces which predominantly do not occur in the reservoir, and are merely kinetically stabilized).

The Winsor type III microemulsion is in an equilibrium with excess water and excess oil. Under these conditions of microemulsion formation, the surfactants cover the oil-water interface and lower the interfacial tension σ more preferably to values of <10⁻² mN/m (ultralow interfacial tension). In order to achieve an optimal result, the proportion of the microemulsion in the water-microemulsion-oil system, for a defined amount of surfactant, should naturally be at a maximum, since this allows lower interfacial tensions to be achieved.

In this manner, it is possible to alter the form of the oil droplets (interfacial tension between oil and water is lowered to such a degree that the smallest interface state is no longer favored and the spherical form is no longer preferred), and they can be forced through the capillary openings by the flooding water.

When all oil-water interfaces are covered with surfactant, in the presence of an excess amount of surfactant, the Winsor type III microemulsion forms. It thus constitutes a reservoir for surfactants which cause a very low interfacial tension between oil phase and water phase. By virtue of the Winsor type III microemulsion being of low viscosity, it also migrates through the porous deposit rock in the flooding process (emulsions, in contrast, can become trapped in the porous matrix and block deposits). When the Winsor type III microemulsion meets an oil-water interface as yet uncovered with surfactant, the surfactant from the microemulsion can significantly lower the interfacial tension of this new interface, and lead to mobilization of the oil (for example by deformation of the oil droplets).

The oil droplets can subsequently combine to give a continuous oil bank. This has two advantages:

Firstly, as the continuous oil bank advances through new porous rock, the oil droplets present there can coalesce with the bank.

Moreover, the combination of the oil droplets to give an oil bank significantly reduces the oil-water interface and hence surfactant no longer required is released again. Thereafter, the surfactant released, as described above, can mobilize oil droplets remaining in the formation.

Winsor type III microemulsion flooding is consequently an exceptionally efficient process, and requires much less surfactant compared to an emulsion flooding process. In microemulsion flooding, the surfactants are typically optionally injected together with cosolvents and/or basic salts (optionally in the presence of chelating agents). Subsequently, a solution of thickening polymer is injected for mobility control. A further variant is the injection of a mixture of thickening polymer and surfactants, cosolvents and/or basic salts (optionally with chelating agent), and then a solution of thickening polymer for mobility control. These solutions should generally be clear in order to prevent blockages of the reservoir.

The requirements on surfactants for tertiary mineral oil production differ significantly from requirements on surfactants for other applications: suitable surfactants for tertiary oil production should reduce the interfacial tension between water and oil (typically approx. 20 mN/m) to particularly low values of less than 10⁻² mN/m in order to enable sufficient mobilization of the mineral oil. This has to be done at the customary deposit temperatures of approx. 15° C. to 130° C. and in the presence of water with a high salt content, more particularly also in the presence of high proportions of calcium and/or magnesium ions; the surfactants thus also have to be soluble in deposit water with a high salt content.

To fulfill these requirements, there have already been frequent proposals of mixtures of surfactants, especially mixtures of anionic and nonionic surfactants.

U.S. Pat. No. 3,811,507 describes the combination of linear alkylsulfonates or alkylarylsulfonates with alkyl ether sulfates, the alkyl ether sulfate being an alkyl polyethyleneoxysulfate.

GB 2,168,094 describes the combination of internal olefinsulfonates with alkyl ether sulfonates.

U.S. Pat. No. 7,119,125 B1 describes a mixture of sulfonated Guerbet alcohol alkoxylate and of low molecular weight sulfonated alkyl alkoxylate in oil production. Particularly good emulsifying properties are attributed to the bimodal distribution. However, these emulsifying properties do not play a major role in Winsor type III microemulsion flooding. Too much surfactant would be required for the emulsification of oil, and the shear forces required are barely present in the flooding operation (apart from the region around the injector).

US-A 2009/270281 describes the use of a surfactant mixture for the production of mineral oil, which comprises at least one surfactant with an alkyl radical of 12 to 30 carbon atoms and a branched cosurfactant with an alkyl radical of 6 to 11 carbon atoms. The degree of branching of the alkyl radical in the cosurfactant ranges from 1 to 2.5, and may thus comprise Guerbet alcohols of the 2-ethylhexyl or 2-propylheptyl type. The cosurfactants may be alcohol ethoxylates or anionically modified alcohol ethoxylates (for example alkyl ether sulfate).

US 2011/247,830 A1 describes surfactant mixtures comprising surfactants based on a branched C17H35-alkyl radical.

WO 2011/110502 A1 describes surfactant mixtures comprising surfactants based on a linear C16H33- and C18H37-alkyl radical.

WO 2011/110503 A1 describes surfactant mixtures comprising anionically modified alkyl alkoxylates comprising butyleneoxy units.

Further surfactant mixtures are described in WO 2011/037975 A2, WO2011/110501 A1, WO 2011130310, WO 2011/131549 A1 and WO 2011/131719 A1.

The use parameters, for example type, concentration and mixing ratio of the surfactants used relative to one another, are adjusted by the person skilled in the art to the conditions prevailing in a given oil formation (for example temperature and salt content).

As described above, mineral oil production is proportional to the capillary number. The lower the interfacial tension between oil and water, the higher the capillary number. The higher the mean number of carbon atoms in the crude oil, the more difficult low interfacial tensions are to achieve. For low interfacial tensions, suitable surfactants are those which possess a long hydrophobic radical. This hydrophobic radical may be an alkyl radical or an alkyl radical extended with hydrophobic alkyleneoxy units. The longer the hydrophobic radical, the better the interfacial tensions can be reduced, but the solubility of the compound usually decreases. Therefore, a second surfactant is usually required to improve the solubility or interfacial tension.

It is therefore an object of the present invention to provide a particularly efficient surfactant mixture for use for surfactant flooding, and an improved process for tertiary mineral oil production.

The object is achieved by a surfactant mixture, said surfactant mixture comprising at least one secondary alkanesulfonate of the general formula (I)

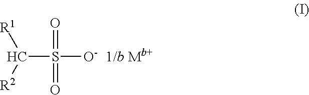

and at least one anionic surfactant of the general formula (II)

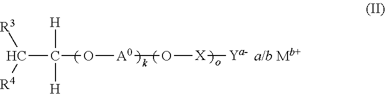

where
R¹ and R² are each independently a linear or branched, saturated aliphatic hydrocarbyl radical, where the R¹CHR² radical has 14 to 17 carbon atoms;
R³ is a linear or branched, saturated or unsaturated aliphatic hydrocarbyl radical and
R⁴ is H or a linear or branched, saturated or unsaturated aliphatic hydrocarbyl radical, where the R³R⁴CHCH₂ radical has 8 to 44 carbon atoms;
each A⁰ is independently ethylene, propylene or butylene;
k is an integer from 1 to 99,
X is a branched or unbranched alkylene group which has 1 to 10 carbon atoms and may be substituted by an OH group;
o is 0 or 1;
each M^{b+} is independently a cation with charge b;
Y^{a-} is a sulfate group, sulfonate group, carboxylate group or phosphate group;
b is 1, 2 or 3 and
a is 1 or 2.

A further aspect of the present invention relates to an aqueous surfactant formulation comprising an inventive surfactant mixture, said aqueous surfactant formulation preferably having a total surfactant content of 0.05 to 5% by weight based on the total amount of the aqueous surfactant formulation.

A further aspect of the present invention relates to the use of an inventive surfactant mixture or of an inventive aqueous surfactant formulation in mineral oil production by means of Winsor type III microemulsion flooding.

A further aspect of the present invention relates to processes for producing mineral oil by means of Winsor type III microemulsion flooding, in which an inventive aqueous surfactant formulation comprising a surfactant mixture, for the purpose of lowering the interfacial tension between oil and water to <0.1 mN/m, is injected through at least one injection well into a mineral oil deposit and crude oil is withdrawn through at least one production well from the deposit.

Accordingly, a mixture of at least one surfactant of the general formula (I) and at least one surfactant of the general formula (II) is provided, as is a process for tertiary mineral oil production by means of Winsor type III microemulsion flooding, in which an aqueous surfactant formulation comprising at least one surfactant of the general formula (I) and at least one surfactant of the general formula (II) is injected into a mineral oil deposit through at least one injection well, this lowering interfacial tension between oil and water to values of <0.1 mN/m, preferably to values of <0.05 mN/m, more preferably to values of <0.01 mN/m, and crude oil is withdrawn through at least one production well from the deposit.

In a preferred embodiment, the weight-based ratio of surfactant of the general formula (I) to surfactant of the general formula (II) is between 1:19 and 19:1. More preferably, the ratio of (I) to (II) is between 1:9 and 9:1. Even more preferably, the ratio of (I) to (II) is between 1:9 and 1:1.01.

In a preferred embodiment, in general formula (I), R¹ is a linear saturated aliphatic hydrocarbyl radical and R² is a linear saturated aliphatic hydrocarbyl radical, where the alkyl radical R¹CHR² is a hydrocarbyl radical having 14 to 17 carbon atoms. Preferably, in formula (I), M^{b+} is Na⁺.

A further preferred embodiment involves a mixture of 4 surfactants of the general formula (I) with different numbers of carbon atoms. In a particularly preferred embodiment, based on the aforementioned mixture of 4 surfactants of the general formula (I) with different numbers of carbon atoms, the proportion of surfactants of the general formula (I) — based in each case on the R¹R²CH— radical having 14 carbon atoms, is 20-30 mol %, the proportion of surfactants of the formula (I) having 15 carbon atoms is 25-30 mol %, the proportion of surfactants of the formula (I) having 16 carbon atoms is 20-30 mol % and the proportion of surfactants of the formula (I) having 17 carbon atoms is mol % 10-20%, based in each case on all R¹R²CH— radicals in these 4 surfactants.

In a further preferred embodiment, in general formula (II), R³ is a linear, saturated or unsaturated aliphatic hydrocarbyl radical having 14 to 16 carbon atoms and R⁴ is a hydrogen atom.

In a very preferred embodiment, in general formula (II), R³ is a linear saturated aliphatic hydrocarbyl radical having 14 or 16 carbon atoms and R⁴ is a hydrogen atom. It is additionally preferred that the proportion by weight of these 2 ionic surfactants of the formula (II) based on the total weight of the inventive surfactant mixture is greater than 50% by weight, more preferably greater than 60% by weight, even more preferably greater than 70% by weight, even more preferably greater than 80% by weight, most preferably greater than 90% by weight.

In a further preferred embodiment, in general formula (II), R³ is a linear or branched, saturated or unsaturated aliphatic hydrocarbyl radical having 10 or 12 carbon atoms and R⁴ is a linear or branched, saturated or unsaturated aliphatic hydrocarbyl radical having 12 or 14 carbon atoms.

In a particularly preferred embodiment, in general formula (II), R³ is a linear saturated or unsaturated (preferably saturated) aliphatic hydrocarbyl radical having 10 or 12 carbon atoms; and R⁴ is a linear saturated or unsaturated (preferably saturated) aliphatic hydrocarbyl radical having 12 or 14 carbon atoms, the result of which is especially the presence of at least 3 ionic surfactants of the formula (II) with hydrocarbyl radicals having 24 carbon atoms, 26 carbon atoms and 28 carbon atoms. If the molar sum of these three surfactants is formed, it is particularly preferable—based in each case on the R³R⁴CHCH₂— radical—for the O₂₄ surfactant of the formula (II) to be present within a range from 40 mol % to 60 mol %, for the C₂₆ surfactant of the formula (II) to be present within a range from 30 mol % to 50 mol % and for the O₂₈ surfactant of the formula (II) to be present within a range from 1 mol % to 20 mol %, based on the sum of the proportions of these surfactants. It is additionally preferred that the proportion by weight of these 3 ionic surfactants based on the total weight of the inventive surfactant mixture is greater than 50% by weight, more preferably greater than 60% by weight, even more preferably greater than 70% by weight, even more preferably greater than 80% by weight, most preferably greater than 90% by weight.

In a further preferred embodiment, in general formula (II), R³ is a linear or branched, saturated or unsaturated aliphatic hydrocarbyl radical having 14 or 16 carbon atoms and R⁴ is a linear or branched, saturated or unsaturated aliphatic hydrocarbyl radical having 16 or 18 carbon atoms.

In a particularly preferred embodiment, in general formula (II), R³ is a linear saturated or unsaturated (preferably saturated) aliphatic hydrocarbyl radical having 14 or 16 carbon atoms; and R⁴ is a linear saturated or unsaturated (preferably saturated) aliphatic hydrocarbyl radical having 16 or 18 carbon atoms, the result of which is especially the presence of at least 3 ionic surfactants of the formula (II) with a hydrocarbyl radical based on the R³R⁴CHCH₂ radical having 32 carbon atoms, 34 carbon atoms and 36 carbon atoms. If the molar sum of these three surfactants is formed, it is particularly preferable for the C₃₂ surfactant of the formula (II) to be present within a range from 20% to 40%, for the C₃₄ surfactant of the formula (II) to be present within a range from 41% to 60% and for the C₃₆ surfactant of the formula (II) to be present within a range from 10% to 35%, based on the sum total. It is additionally preferred that the proportion by weight of these 3 ionic surfactants based on the total weight of the inventive surfactant mixture is greater than 50% by weight, more preferably greater than 60% by weight, even more preferably greater than 70% by weight, even more preferably greater than 80% by weight, most preferably greater than 90% by weight.

The alkyleneoxy (AO) groups OA⁰ in general formula (I), which occur k times, may be the same or different. If they are different, they may be arranged in random distribution, alternately or in blocks, i.e. in two, three, four or more blocks.

Accordingly, in general formula (II), (OA)ₖ may represent n butyleneoxy (BuO), m propyleneoxy (PO) and I ethyleneoxy (E0) groups, where n, m, I are natural numbers including 0, and n+m+l=k.

Preferably, the n butyleneoxy, m propyleneoxy and l ethyleneoxy groups are at least partially arranged in blocks (in numerical terms, preferably to an extent of at least 50 mol %, more preferably to an extent of at least 60%, even more preferably to an extent of at least 70%, more preferably to an extent of at least 80%, more preferably to an extent of at least 90%, especially completely).

In the context of the present invention, “arranged in blocks” means that at least one AO has a neighboring AO group which is chemically identical, such that these at least two AO form a block.

Preferably, the (R³)(R⁴)—CH—CH₂— radical in formula (II) is followed, representing (OA)ₖ, by a butyleneoxy block with n butyleneoxy groups, followed by a propyleneoxy block with m propyleneoxy groups, and finally an ethyleneoxy block with l ethyleneoxy groups.

In the above-defined general formula (II), k and the variables l, m and n are each natural numbers including 0, i.e. 0, 1, 2 etc. It is, however, clear to the person skilled in the art in the field of polyalkoxylates that this definition is the definition of a single surfactant in each case. In the case of presence of surfactant mixtures or aqueous surfactant formulations comprising a plurality of surfactants of the general formula (II), the numbers l, m and n are each mean values over all molecules of the surfactants, since the alkoxylation of alcohol with ethylene oxide or propylene oxide or butylene oxide in each case affords a certain distribution of chain lengths. This distribution can be described in a manner known in principle by what is called the polydispersity D. D=M_{w}/Mₙ is the ratio of the weight-average molar mass and the number-average molar mass. The polydispersity can be determined by methods known to those skilled in the art, for example by means of gel permeation chromatography.

Preferably, in general formula (II), k is an integer in the range from 4 to 50, more preferably in the range from 8 to 39.

The variable l is a number from 0 to 99, preferably 1 to 40, more preferably 1 to 20; m is a number from 0 to 99, preferably 1 to 20, more preferably 4 to 15; n is a number from 0 to 99, preferably 0 to 20, more preferably 1 to 15, and the sum of the variables l, m, n gives a number from (inclusive in each case) 1 to 99.

According to the invention, the sum of l+m+n (=k) is a number in the range from 1 to 99, preferably in the range from 4 to 50, more preferably in the range from 8 to 39.

Preferably, m is an integer from 4 to 15 (more preferably 5 to 9) and/or l is an integer from 0 to 25 (more preferably 4 to 15) and/or n is 0.

Further preferably, m is an integer from 4 to 15 (more preferably 5 to 9) and/or l is an integer from 0 to 25 (more preferably 4 to 15) and/or n is an integer from 1 to 15 (more preferably 5 to 9).

In general formula (II), X is a branched or unbranched alkylene group which has 1 to 10 and preferably 2 to 4 carbon atoms and may be substituted by an OH group. The alkylene group is preferably a methylene, ethylene or propylene group. More particularly, X is preferably CH₂CH₂, CH₂CH(OH)CH₂, (CH₂)₃, CH₂ or CH₂CH(R′), where R′ is hydrogen or an alkyl radical having 1 to 4 carbon atoms (for example methyl). X may be present (o=1) or absent (o=0).

In the above general formulae (I) and (II), M⁺ is in each case independently a cation, the cation preferably being selected from the group consisting of Na⁺; K⁺, Li⁺, NH₄⁺, H⁺, Mg²⁺ and Ca²⁺ (preferably Na⁺, K⁺or NH₄⁺). Overall, b may have the values of 1, 2 or 3. Preferably, b is 1 or 2, especially 1. Each M⁺ may be the same or different for formula (I), but preferably the same. Each M⁺ may be the same or different for formula (II), but preferably the same. The cations M⁺ may be the same or different in comparison to formula (I) and formula (II), but preferably the same.

In the above general formula (II), Y^{a-} is a sulfonate, sulfate, carboxylate or phosphate group (preferably sulfonate, sulfate or carboxylate group, especially preferably sulfate or carboxylate). Thus, a may have the values of 1 or 2.

Preferably, in general formula (II), the (OX)ₒY^{a-} radical is OS(O)₂O⁻, OCH₂CH₂S(O)₂O⁻, OCH₂CH(OH)CH₂S(O)₂O⁻, O(CH₂)₃S(O)₂O⁻, O(CH₂)₄S(O)₂O⁻, S(O)₂O⁻, CH₂C(O)O⁻ or CH₂CH(R′)C(O)O⁻, where R′ is hydrogen or an alkyl radical having 1 to 4 carbon atoms (for example methyl).

In a further preferred embodiment, the invention relates to a mixture of at least one surfactant of the general formula (I) and at least one surfactant of the general formula (II), and to the use thereof in mineral oil production by means of Winsor type III microemulsion flooding, where l is an integer from 0 to 99, m is a number from 4 to 15 and n is a number from 0 to 15, and Y^{a-} is selected from the group consisting of sulfate group, sulfonate group and carboxylate group, where the BuO, PO and EO groups are present to an extent of more than 80% in block form in the sequence BuO, PO, EO beginning from (R³)(R⁴)—CH—CH₂ and the sum of l+m+n is in the range from 5 to 49.

A particularly preferred embodiment is when l is an integer from 0 to 99, m is a number from 5 to 9 and n is a number from 1 to 15, and Y^{a-} is selected from the group consisting of sulfate group, sulfonate group and carboxylate group, where the BuO, PO and EO0 groups are present to an extent of more than 80% in block form in the sequence BuO, PO and EO beginning from (R³)(R⁴)—CH—CH₂, the sum of l+m+n is in the range from 4 to 50 and the BuO block consists to an extent of more than 80% of 1,2-butylene oxide.

A preferred inventive surfactant mixture comprises, in addition to at least one surfactant of the general formula (I) and at least one surfactant of the general formula (II), additionally at least one surfactant of the general formula (III)

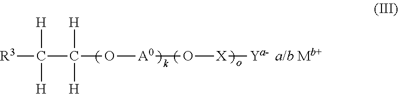

and at least one surfactant of the general formula (IV)

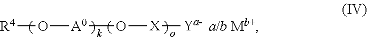

where R³, R⁴, A⁰, X, Y^{a-}, M^{b+}, k, o, a and b each have the definition and preferred definitions given for the general formula (II).

Preferably, the proportion of surfactants of the general formula (II) in relation to the sum of the amounts of surfactants of the formulae (I), (II), (III) and (IV) is in the range from 80% by weight to 99% by weight.

In a further preferred embodiment of the invention, R³ in the general formula (III) is a linear saturated aliphatic hydrocarbyl radical having 10 or 12 carbon atoms, and R⁴ in the general formula (IV) is a linear saturated aliphatic hydrocarbyl radical having 12 or 14 carbon atoms.

In a further preferred embodiment of the invention, R³ in the general formula (III) is a linear saturated aliphatic hydrocarbyl radical having 14 or 16 carbon atoms, and R⁴ in the general formula (IV) is a linear saturated aliphatic hydrocarbyl radical having 16 or 18 carbon atoms.

As a result of the preparation, it is also possible for more than one surfactant of the general formula (II) to be present in the surfactant mixture. The surfactants which differ in terms of the hydrocarbyl moiety (R³)(R⁴)—CH—CH₂— can be encompassed by the general formula (II). The difference can arise through the number of carbon atoms, the number of unsaturated bonds, the branching frequency and/or the degree of branching. More particularly, the surfactants differ in the chain length for R³ and R⁴.

The alkyl radical R³R⁴CHCH₂ is a hydrocarbyl radical having 8 to 44 carbon atoms. These may be linear or branched, saturated or unsaturated aliphatic hydrocarbyl radicals of the R³R⁴CHCH₂ type. R⁴ may optionally also be a hydrogen atom.

In the case of branched hydrocarbyl radicals of the R³R⁴CHCH₂ type, preference is given to degrees of branching of 0.1 to 5. More preferred degrees of branching are from 0.1 to 3.5 (even more preferably 0.1 to 2.5).

In this context, the term “degree of branching” is defined in a manner known in principle as the number of methyl groups in one molecule of the alcohol minus 1. The mean degree of branching is the statistical mean of the degrees of branching of all molecules in a sample.

In illustrative compounds obtainable by hydrogenation of fatty acid methyl esters, in a preferred embodiment, R³ is a linear, saturated or unsaturated aliphatic hydrocarbyl radical having 14 to 16 carbon atoms and R⁴ is a hydrogen atom. In a very preferred embodiment, R³ is a linear saturated aliphatic hydrocarbyl radical having 14 or 16 carbon atoms and R⁴ is a hydrogen atom.

Illustrative compounds obtainable by dimerization of alcohols lead to R³/R⁴ hydrocarbyl chains having 10/12, 10/13, 10/14, 11/12, 11/13, 11/14, 12/12, 12/13, 12/14, preferably 10/12, 10/14, 12/12, 12/14, carbon atoms. As a result of the preparation, it is also possible for more than three different surfactants of the general formula (II) to be present in the surfactant mixture. The three surfactants having, with respect to the hydrocarbyl moiety (R³)(R⁴)—CH—CH₂—, 24, 26 and 28 carbon atoms preferably constitute the main components of the inventive surfactant mixture. The proportion thereof is preferably at least 25% by weight, based on the total weight of the surfactant mixture, more preferably at least 30% by weight, more preferably at least 40% by weight, more preferably at least 50% by weight. The R³ radical is a linear or branched, saturated or unsaturated aliphatic hydrocarbyl radical having 10 to 12 carbon atoms. The R⁴ radical is a linear or branched, saturated or unsaturated aliphatic hydrocarbyl radical having 12 to 14 carbon atoms. R³ is either identical to R⁴ or preferably has a maximum of two carbon atoms (more preferably exactly two carbon atoms) fewer than R⁴. In the case of branched R³ or R⁴ radicals, the degree of branching in R³ or R⁴ is preferably in the range of 0.1-5 (more preferably of 0.1-1.5). For the branched aliphatic hydrocarbyl radical (R³)(R⁴)—CHCH₂, this gives rise to a degree of branching of 1.2 to 11 (preferably 1.2 to 4). However, a further preferred embodiment is the use of linear saturated or unsaturated R³ radicals having 10 or 12 carbon atoms, or R⁴ having 12 or 14 carbon atoms. Particular preference is given to the use of linear saturated R³ and R⁴ radicals. For the aliphatic hydrocarbyl radical (R³)(R⁴)—CHCH₂, this gives rise to a degree of branching of 1.

Illustrative compounds obtainable by dimerization of alcohols lead to R³/R⁴ alkyl chains having 14/16, 14/17, 14/18, 15/16, 15/17, 15/18, 16/16, 16/17, 16/18, especially 14/16, 14/18, 16/16, 16/18, carbon atoms. As a result of the preparation, it is also possible for more than three different surfactants of the general formula (II) to be present in the surfactant mixture. The three surfactants preferably constitute the main components of the surfactant mixture. The proportion thereof is preferably at least 25% by weight, based on the total weight of the surfactant mixture, more preferably at least 30% by weight, more preferably at least 40% by weight, more preferably at least 50% by weight. The R³ radical is a linear or branched, saturated or unsaturated aliphatic hydrocarbyl radical having 14 to 16 carbon atoms. The R⁴ radical is a linear or branched, saturated or unsaturated aliphatic hydrocarbyl radical having 16 to 18 carbon atoms. R³ is either identical to R⁴ or has a maximum of two carbon atoms (more preferably exactly two carbon atoms) fewer than R⁴. In the case of branched R³ or R⁴ radicals, the degree of branching in R³ or R⁴ is preferably in the range of 0.1-5 (more preferably of 0.1-1.5). For the branched aliphatic hydrocarbyl radical (R³)(R⁴)—CHCH₂, this gives rise to a degree of branching of 1.2 to 11 (preferably 1.2 to 4). However, a further preferred embodiment is the use of linear saturated or unsaturated R³ radicals having 14 or 16 carbon atoms, or R⁴ having 14 or 16 carbon atoms. Particular preference is given to the use of linear saturated R³ and R⁴ radicals. For the aliphatic hydrocarbyl radical (R³)(R⁴)—CHCH₂, this gives rise to a degree of branching of 1.

The alcohols (R³)(R⁴)—CH—CH₂—OH which can serve as starting compounds for preparation of the inventive surfactants are obtainable, for example, by hydrogenation of fatty acid methyl esters (R⁴ is a hydrogen atom), oxo alcohol synthesis or dimerization of alcohols of the R³CH₂CH₂OH and R⁴OH type (R⁴ is not a hydrogen atom) with elimination of water.

Accordingly, a further aspect of the present invention is a process for preparing an inventive surfactant mixture, comprising the steps of:

For surfactants of the general formula (I):
(a) preparation of a secondary alkanesulfonate of the general formula (I) where R¹ and R² are each as defined above by sulfoxidation of an alkane mixture and subsequent reaction with alkali. An alternative is to undertake sulfochlorination of alkanes with subsequent reaction with alkali.

The preparation of the surfactant of the general formula (I) in process step (a) is known to those skilled in the art. In the typically preferred sulfoxidation process, an alkane mixture is mixed with water and irradiated at 20-40° C. with UV light (e.g. 10-40 kW mercury vapor lamps), while passing through a mixture of sulfur dioxide and oxygen (molar ratio preferably 2:1). In order to prevent the formation of polysulfonated compounds, the conversion is preferably limited to <5% (preferably ≦1%), and the target compounds are discharged. Unconverted alkane is recycled into the process. The process preferably runs continuously. The alkanesulfonic acids obtained are removed from the residual alkane by phase separation. After removal of gases (SO₂, SO₃), the alkanesulfonic acid is reacted with alkali—preferably sodium hydroxide solution—to give the surfactant.

For surfactants of the general formula (II):
(a′) preparation of a fatty alcohol of the general formula (R³)(R⁴)—CH—CH₂OH (V), where R³ and R⁴ are each as defined above—with the restriction that R³ is a linear saturated or unsaturated hydrocarbyl radical and R⁴ is a hydrogen atom—by hydrolysis of a natural fat (triglyceride) with the aid of methanol and subsequent hydrogenation of the methyl ester to give the fatty alcohol. Alternatively, the triglyceride can be hydrolyzed to the fatty acid, followed by hydrogenation to the fatty alcohol. A further alternative is the preparation of the alcohols by the Ziegler process, by oligomerization of ethylene over an aluminum catalyst and subsequent hydrolysis with water.
(b′) alkoxylation of the alcohols obtained in process step (a′),
(c′) reaction of the alcohol alkoxylates obtained in step (b′) with a Y^{a-} group, optionally with formation of a spacer group OX.

The preparation of the fatty alcohol of the general formula (V) (R³)(R⁴)—CH—CH₂OH in process step (a′) is known to those skilled in the art.

This may be, inter alia, a C16C18 fatty alcohol mixture (linear, saturated), a C16C18 fatty alcohol mixture (linear and partly unsaturated) or a C16C18 mixture of Ziegler alcohols having 16 or 18 carbon atoms.

For surfactants of the general formula (II):
(a″) preparation of an oxo alcohol of the general formula (R³)(R⁴)—CH—CH₂OH (V) where R³ and R⁴ are each as defined above, by reaction of an olefin with carbon monoxide and hydrogen.
(b″) alkoxylation of the alcohols obtained in process step (a″),
(c″) reaction of the alcohol alkoxylates obtained in step (b″) with a Y^{a-} group, optionally with formation of a spacer group OX.

The preparation of the oxo alcohol of the general formula (V) (R³)(R⁴)—CH—CH₂OH in process step (a″) is known to those skilled in the art.

For surfactants of the general formula (II):
(a′″) preparation of Guerbet alcohols of the general formula (V) (R³)(R⁴)—CH—CH₂OH (V), where R³ and R⁴ are each as defined above—with the restriction that R⁴ is not a hydrogen atom and R³CH₂CH₂OH and R⁴OH have the same number of carbon atoms or differ by not more than 2 carbon atoms—by condensation of a mixture of at least two primary alcohols of the formula R—CH₂—CH₂—OH,
(b′″) alkoxylation of the alcohols obtained in process step (a′″),
(c′″) reaction of the alcohol alkoxylates obtained in step (b′″) with a Y^{a-} group, optionally with formation of a spacer group OX.

The preparation of the Guerbet alcohol of the general formula (V) (R³)(R⁴)—CH—CH₂OH in process step (a′″) is known to those skilled in the art.

In the course of the Guerbet reaction, primary alcohols are finally dimerized in the presence of suitable catalysts to β-branched primary alcohols. The primary products formed from the alcohol are aldehydes, which subsequently dimerize by aldol condensation with elimination of water and subsequent hydrogenation to give saturated alcohols. In addition to the main product, the Guerbet alcohol, it is also possible for various by-products to form, for example unsaturated β-branched primary alcohols if the hydrogenation of the double bond is incomplete, saturated α-branched aldehydes if the hydrogenation to give the Guerbet alcohol was incomplete, or more particularly β-branched primary alcohols which have additional branches in the side chain or main chain.

The dimerization of the alcohols of the formula R—CH₂CH₂—OH may give rise to a mixture of alcohols. This may be, inter alia, a C12C14 fatty alcohol mixture (linear, saturated), a C12C14 mixture of Ziegler alcohols having 12 and 14 carbon atoms, a C12C14 fatty alcohol mixture (linear and partly unsaturated) or a mixture of C12C14 oxo alcohol.

The dimerization of the alcohols of the formula R—CH₂CH₂—OH where R is a linear or branched, saturated or unsaturated aliphatic hydrocarbyl radical having 10 or 12 carbon atoms affords, in a preferred embodiment of the invention, Guerbet alcohols having 24, 26 and 28 carbon atoms.

In a particularly preferred embodiment, R is a linear saturated or unsaturated (preferably saturated) aliphatic hydrocarbyl radical having 10 or 12 carbon atoms.

For preparation of the Guerbet alcohols in process step (a′″), mixtures of the alcohols of the formula R—CH₂CH₂—OH are condensed. Preferably, the proportion of alcohols where R=10 carbon atoms is between 60-80 mol %, the proportion of alcohols where R=12 carbon atoms between 20-40 mol %. Particular preference is given to reacting about 70 mol % of alcohols where R=10 carbon atoms and 30 mol % of alcohols where R=12 carbon atoms.

This may be, inter alia, a C16C18 fatty alcohol mixture (linear, saturated), a C16C18 mixture of Ziegler alcohols having 16 and 18 carbon atoms, a C16C18 fatty alcohol mixture (linear and partly unsaturated) or a mixture of C16C18 oxo alcohol.

The dimerization of the alcohols of the formula R—CH₂CH₂—OH where R is a linear or branched, saturated or unsaturated aliphatic hydrocarbyl radical having 14 or 16 carbon atoms affords, in a preferred embodiment of the invention, Guerbet alcohols having 32, 34 and 36 carbon atoms.

In a particularly preferred embodiment, R is a linear saturated or unsaturated (preferably saturated) aliphatic hydrocarbyl radical having 14 or 16 carbon atoms.

For preparation of the Guerbet alcohols in process step (a′″), mixtures of the alcohols of the formula R—CH₂CH₂—OH are condensed. Preferably, the proportion of alcohols where R=14 carbon atoms is between 25 and 50 mol %, the proportion of alcohols where R=16 carbon atoms between 50 and 75 mol %. Particular preference is given to reacting about 30 mol % of alcohols where R=14 carbon atoms and 70 mol % of alcohols where R=16 carbon atoms.

The condensation of alcohols of the formula R—CH₂CH₂—OH to give Guerbet alcohols is preferably performed in the presence of 0.5 to 10% by weight, based on the alcohol, of alkali metal or alkaline earth metal hydroxide, for example lithium hydroxide, sodium hydroxide, cesium hydroxide or potassium hydroxide, preferably potassium hydroxide. With a view to a high reaction rate and a low proportion of secondary components, the alkali metal hydroxides or alkaline earth metal hydroxides are used in a concentration of 3 to 6% by weight, based on the alcohol. The alkali metal hydroxide or alkaline earth metal hydroxide can be used in solid form (flakes, powder) or in the form of a 30 to 70%, preferably 50%, aqueous solution.

In a preferred embodiment, the alcohols of the formula R—CH₂CH₂—OH are condensed in the presence of NaOH and/or KOH.

Suitable catalysts are the catalysts known from the prior art, for example nickel salts and lead salts (U.S. Pat. No. 3,119,880), copper oxide, lead oxide, zinc oxide, chromium oxide, molybdenum oxide, tungsten oxide and manganese oxide (U.S. Pat. No. 3,558,716), palladium complexes (U.S. Pat. No. 3,979,466) or silver complexes (U.S. Pat. No. 3,864,407). Preference is given to using ZnO as a catalyst for the dimerization. The catalyst(s) preferably comprise(s) ZnO catalysts, which are generally added to the mixture from which the Guerbet alcohols are prepared.

The mixture of Guerbet alcohols can be prepared by the process known from DE 3901095 A1.

In a preferred embodiment of the invention, the Guerbet alcohols are synthesized in process step (a′″) at a temperature in the range from 150 to 320° C., preferably at a temperature in the range from 180 to 280° C., optionally in the presence of a catalyst or a plurality of catalysts.

The alcohols obtained in process step (a′, a″, a′″) (R³)(R⁴)—CH—CH₂—OH can be converted in a manner known in principle by alkoxylation in process step (b′, b″, b′″) to alcohol alkoxylates. The performance of such alkoxylations is known in principle to those skilled in the art. It is likewise known to those skilled in the art that the reaction conditions, especially the selection of the catalyst, can influence the molecular weight distribution of the alkoxylates.

The alcohol alkoxylates can be prepared in process step (b′, b″, b′″) preferably by base-catalyzed alkoxylation. In this case, the alcohol (R³)(R⁴)—CH—CH₂—OH can be admixed in a pressure reactor with alkali metal hydroxides, preferably potassium hydroxide, or with alkali metal alkoxides, for example sodium methoxide. Water still present in the mixture can be drawn off by means of reduced pressure (for example <100 mbar) and/or increasing the temperature (30 to 150° C.). Thereafter, the alcohol is present in the form of the corresponding alkoxide. This is followed by inertization with inert gas (for example nitrogen) and stepwise addition of the alkylene oxide(s) at temperatures of 60 to 180° C. up to a maximum pressure of 10 bar. In a preferred embodiment, the alkylene oxide is metered in initially at 130° C. In the course of the reaction, the heat of reaction released causes the temperature to rise up to 170° C. In a further preferred embodiment of the invention, the butylene oxide is first added at a temperature in the range from 125 to 145° C., then the propylene oxide is added at a temperature in the range from 130 to 145° C., and subsequently the ethylene oxide is added at a temperature in the range from 125 to 155° C. At the end of the reaction, the catalyst can, for example, be neutralized by adding acid (for example acetic acid or phosphoric acid) and be filtered off if required.

However, the alkoxylation of the alcohols (R³)(R⁴)—CH—CH₂—OH can also be undertaken by means of other methods, for example by acid-catalyzed alkoxylation. In addition, it is possible to use, for example, double hydroxide clays, as described in DE 4325237 A1, or it is possible to use double metal cyanide catalysts (DMC catalysts). Suitable DMC catalysts are disclosed, for example in DE 10243361 A1, especially in paragraphs [0029] to [0041] and the literature cited therein. For example, it is possible to use catalysts of the Zn—Co type. To perform the reaction, the alcohol (R³)(R⁴)—CH—CH₂—OH can be admixed with the catalyst, and the mixture dewatered as described above and reacted with the alkylene oxides as described. Typically not more than 1000 ppm of catalyst based on the mixture are used, and the catalyst can remain in the product owing to this small amount. The amount of catalyst may generally be less than 1000 ppm, for example 250 ppm or less.

Process step (c′, c″, c′″) relates to the reaction of the alcohol alkoxylates obtained in step (b′, b″, b′″) with a Y^{a-} group, optionally with formation of a spacer group OX.

For example, it is possible to introduce sulfate and phosphate groups by reacting them with the alcohol alkoxylate directly (optionally after activation). Sulfonate groups can be introduced by vinyl addition, substitution reaction or aldol reaction, optionally with subsequent hydrogenation, to obtain corresponding spacers OX. Alternatively, the alcohol alkoxylate can also be converted to a chloride beforehand, which is subsequently amenable to a direct sulfonation. Carboxylates can be obtained, for example, by reaction with chloroacetate, acrylate or substituted acrylates H₂C═(R′)C(O)O⁻, where R′ is H or an alkyl radical having 1 to 4 carbon atoms.

In principle, the anionic group (OX)₀Y^{a-} is composed of the functional group Y^{a-}, which is a sulfate, sulfonate, carboxylate or phosphate group, and the spacer OX, which in the simplest case (o=0) may be a single bond. In the case of a sulfate group, it is possible, for example, to employ the reaction with sulfuric acid, chlorosulfonic acid or sulfur trioxide in a falling-film reactor with subsequent neutralization. In the case of a sulfonate group, it is possible, for example, to employ the reaction with propane sultone and subsequent neutralization, with butane sultone and subsequent neutralization, with vinylsulfonic acid sodium salt or with 3-chloro-2-hydroxypropanesulfonic acid sodium salt. To prepare sulfonates, the terminal OH group can also be converted to a chloride, for example with phosgene or thionyl chloride, and then reacted, for example, with sulfite. In the case of a carboxylate group, it is possible, for example, to employ the oxidation of the alcohol with oxygen and subsequent neutralization, or the reaction with chloroacetic acid sodium salt. Carboxylates can also be obtained, for example, by Michael addition of (meth)acrylic acid or ester. Phosphates can be obtained, for example, by esterification reaction with phosphoric acid or phosphorus pentachloride.

In addition to the surfactants of the general formulae (I), (II), (III) and (IV), the surfactant mixture may additionally optionally comprise further surfactants. For example, secondary alkanesulfonates having 12, 13 or 18 carbon atoms or primary alkanesulfonates having 12 to 18 carbon atoms may be present. Further surfactants may also be alkanedisulfonates. These may have, for example, 12 to 18 carbon atoms. It is also possible, however, to use anionic surfactants of the alkylarylsulfonate or olefinsulfonate type (alpha-olefinsulfonate or internal olefinsulfonate), alkyl ether sulfonate, alkyl ether carboxylate, alkyl ether sulfate and/or nonionic surfactants of the alkyl ethoxylate or alkyl polyglucoside type. It is also possible to use betaine surfactants. These further surfactants may especially also be oligomeric or polymeric surfactants. It is advantageous to use such polymeric cosurfactants to reduce the amount of surfactants needed to form a microemulsion. Such polymeric cosurfactants are therefore also referred to as “microemulsion boosters”. Examples of such polymeric surfactants comprise amphiphilic block copolymers which comprise at least one hydrophilic block and at least one hydrophobic block. Examples comprise polypropylene oxide-polyethylene oxide block copolymers, polyisobutene-polyethylene oxide block copolymers, and comb polymers with polyethylene oxide side chains and a hydrophobic main chain, where the main chain preferably comprises essentially olefins or (meth)acrylates as monomers. The term “polyethylene oxide” here shall in each case include polyethylene oxide blocks comprising propylene oxide units as defined above. Further details of such surfactants are disclosed in WO 2006/131541 A1.

In the process according to the invention for mineral oil production, a suitable aqueous surfactant formulation of the inventive surfactant mixture is injected through at least one injection well into the mineral oil deposit, and crude oil is withdrawn from the deposit through at least one production well. The term “crude oil” in this context of course does not mean single-phase oil, but rather the usual crude oil-water emulsions. In general, a deposit is provided with several injection wells and with several production wells.

In the context of the process according to the invention for tertiary mineral oil production by means of Winsor type III microemulsion flooding, the use of the inventive aqueous surfactant formulation lowers the interfacial tension between oil and water to values of <0.1 mN/m, preferably to <0.05 mN/m, more preferably to <0.01 mN/m. Thus, the interfacial tension between oil and water is lowered to values in the range from 0.1 mN/m to 0.0001 mN/m, preferably to values in the range from 0.05 mN/m to 0.0001 mN/m, more preferably to values in the range from 0.01 mN/m to 0.0001 mN/m.

The main effect of the inventive surfactant mixture lies in the reduction of the interfacial tension between water and oil—desirably to values distinctly <0.1 mN/m. After the injection of the aqueous surfactant formulation, called the “surfactant flooding” or preferably the Winsor type III “microemulsion flooding”, the pressure can be maintained by injecting water into the formation (“water flooding”), or preferably a higher-viscosity aqueous solution of a polymer with high thickening action (“polymer flooding”). There are also known techniques in which the surfactants are first of all allowed to act on the formation. A further known technique is the injection of a solution of surfactants and thickening polymers, followed by a solution of thickening polymer. The person skilled in the art is aware of details of the industrial performance of “surfactant flooding”, “water flooding”, and “polymer flooding”, and employs an appropriate technique according to the type of deposit.

For the process according to the invention, an aqueous surfactant formulation comprising at least surfactants of the general formula (I) and formula (II) is used. The aqueous surfactant formulation may, as well as the surfactant mixture, also comprise further components.

In addition to water, the formulations may optionally also comprise water-miscible or at least water-dispersible organic substances or other substances as a cosolvent. Such additives serve especially to stabilize the surfactant solution during storage or transport to the oil field. The amount of such cosolvents should, however, generally not exceed 50% by weight, preferably 20% by weight, based on the total weight of the aqueous surfactant formulation. Examples of such cosolvents comprise especially alcohols such as methanol, ethanol and n-propanol, isopropanol, n-butanol, isobutanol, sec-butanol, n-pentanol, isopentanol, butyl monoethylene glycol, butyl diethylene glycol or butyl triethylene glycol. In a particularly advantageous embodiment of the invention, exclusively water is used for formulation.

In a preferred embodiment of the invention, the surfactants of the general formula (II) should constitute the main component among all the surfactants in the aqueous formulation which is ultimately injected into the deposit. This is preferably at least 25% by weight, more preferably at least 30% by weight, even more preferably at least 40% by weight and even more preferably still at least 50% by weight, based on the total weight of all surfactants used.

The inventive aqueous surfactant formulation can preferably be used for surfactant flooding of deposits. It is especially suitable for Winsor type III microemulsion flooding (flooding in the Winsor III range or in the range of existence of the bicontinuous microemulsion phase). The technique of microemulsion flooding has already been described in detail at the outset.

In addition to the surfactant mixture, the aqueous surfactant formulation may also comprise further components, for example C₄ to C₈ alcohols and/or basic salts (called “alkali surfactant flooding”). Such additives can be used, for example, to reduce retention in the formation. The ratio of the alcohols based on the total amount of surfactant used is generally at least 1:1—however, it is also possible to use a significant excess of alcohol. Suitable basic salts are sodium carbonate, sodium hydrogencarbonate, sodium hydroxide, potassium hydroxide or silicates. The amount of basic salts is typically from 0.1% by weight to 5% by weight, based on the total amount of the aqueous surfactant formulation. At least one chelating agent may be added to the basic salts.

The deposits in which the process is employed generally have a temperature of at least 10° C., for example 10 to 150° C., preferably a temperature of at least 15° C. to 120° C. The total concentration of all surfactants together is 0.05 to 5% by weight, based on the total amount of the aqueous surfactant formulation, preferably 0.1 to 2.5% by weight. The person skilled in the art makes a suitable selection according to the desired properties, especially according to the conditions in the mineral oil formation. It is clear here to the person skilled in the art that the concentration of the surfactants can change after injection into the formation because the formulation can mix with formation water, or surfactants can also be absorbed on solid surfaces of the formation. It is the great advantage of the mixture used in accordance with the invention that the surfactants lead to a particularly good lowering of interfacial tension.

It is of course possible and also advisable first to prepare a concentrate which is only diluted on site to the desired concentration for injection into the formation. In general, the total concentration of the surfactants in such a concentrate is 10 to 45% by weight.

### EXAMPLES

### Part I

### Synthesis of the Surfactants of the General Formula (II)

### General Method 1: Preparation of the Guerbet Alcohol

A 1 l flask is initially charged with the alcohol(s) (1 eq.), which is/are melted if necessary at 50° C. KOH powder (0.24 eq.) and zinc oxide (5% by weight based on the starter alcohol) are added while stirring. The reaction mixture is heated as quickly as possible to 180-230° C. and the water of reaction which forms is distilled off via a distillation outlet. For the fastest possible removal of the water of reaction, the glass flask is optionally insulated with aluminum foil. The reaction mixture is stirred at the given temperature for a further 6 to 30 hours. The alcohol mixture formed is analyzed by gas chromatography and used for the subsequent alkoxylation without further workup.

General Method 2: Alkoxylation by Means of KOH Catalysis (Relevant to Use of EO, PO and/or 1,2-BuO)

In a 2 l autoclave, the alcohol to be alkoxylated (1.0 eq) is optionally admixed with an aqueous KOH solution comprising 50% by weight of KOH. The amount of KOH is 0.2% by weight of the product to be prepared. The mixture is dewatered while stirring at 100° C. and 20 mbar for 2 h. This is followed by purging three times with N₂, establishment of a supply pressure of approx. 1.3 bar of N₂ and an increase in the temperature to 120 to 130° C. The alkylene oxide is metered in such that the temperature remains between 125° C. and 155° C. (in the case of ethylene oxide) or 130 and 145° C. (in the case of propylene oxide) or 125 and 145° C. (in the case of 1,2-butylene oxide). This is followed by stirring at 125 to 145° C. for a further 5 h, purging with N₂, cooling to 70° C. and emptying of the reactor. The basic crude product is neutralized with the aid of acetic acid. Alternatively, neutralization can also be effected with commercial magnesium silicates, which are subsequently filtered off. The light-colored product is characterized with the aid of a ¹H NMR spectrum in CDCl₃, gel permeation chromatography and an OH number determination, and the yield is determined.

### General Method 3: Alkoxylation by Means of DMC Catalysis

In a 2 l autoclave, the alcohol to be alkoxylated (1.0 eq) is mixed with a double metal cyanide catalyst (e.g. DMC catalyst from BASF, Zn—Co type) at 80° C. To activate the catalyst, approx. 20 mbar is applied at 80° C. for 1 h. The amount of DMC is 0.1% by weight of the product to be prepared or less. This is followed by purging three times with N₂, establishment of a supply pressure of approx. 1.3 bar of N₂ and an increase in the temperature to 120 to 130° C. The alkylene oxide is metered in such that the temperature remains between 125° C. and 135° C. (in the case of ethylene oxide) or 130 and 140° C. (in the case of propylene oxide) or 135 and 145° C. (in the case of 1,2-butylene oxide). This is followed by stirring at 125 to 145° C. for a further 5 h, purging with N₂, cooling to 70° C. and emptying of the reactor. The light-colored product is characterized with the aid of a ¹H NMR spectrum in CDCl₃, gel permeation chromatography and an OH number determination, and the yield is determined.

### General Method 4: Sulfonation by Means of Chlorosulfonic Acid

In a 1 l round-bottom flask, the alkyl alkoxylate to be sulfonated (1.0 eq) is dissolved in 1.5 times the amount of dichloromethane (based on percent by weight) and cooled to 5 to 10° C. Thereafter, chlorosulfonic acid (1.1 eq) is added dropwise at such a rate that the temperature does not exceed 10° C. The mixture is allowed to warm up to room temperature and is left to stir at this temperature under N₂ flow for 4 h, before the above reaction mixture is added dropwise to an aqueous NaOH solution of half the volume at max, 15° C. The amount of NaOH is calculated so as to give a slight excess based on the chlorosulfonic acid used. The resulting pH is approx. pH 9 to 10. The dichloromethane is removed on a rotary evaporator at max. 50° C. under a gentle vacuum.

The product is characterized by ¹H NMR and the water content of the solution is determined (approx. 80%).

For the synthesis, the alcohols below were used,

| Alcohol | Description |
|---|---|
| C₁₆C₁₈ | commercially available fatty alcohol mixture consisting of linear |
| | C₁₆H₃₃—OH and C₁₈H₃₇—OH |
| C₁₂C₁₄ | commercially available fatty alcohol mixture consisting of linear |
| | C₁₂H₂₅—OH and C₁₄H₂₉—OH |

### Performance Tests

The surfactants obtained were used to conduct the following tests, in order to assess the suitability thereof for tertiary mineral oil production.

### Description of the Test Methods

### Determination of SP*

### a) Principle of the Measurement:

The interfacial tension between water and oil can be determined in a known manner via the measurement of the solubilization parameter SP*. The determination of the interfacial tension via the determination of the solubilization parameter SP* is a method for approximate determination of the interfacial tension which is accepted in the technical field. The solubilization parameter SP* indicates how many ml of oil are dissolved per ml of surfactant used in a microemulsion (Winsor type III). The interfacial tension σ (IFT) can be calculated therefrom via the approximate formula IFT≈0.3/(SP*)², if equal volumes of water and oil are used (C. Huh, J. Coll. Interf. Sc., Vol. 71, No. 2 (1979)).

### b) Procedure

To determine the SP*, a 100 ml measuring cylinder with a magnetic stirrer bar is filled with 20 ml of oil and 20 ml of water. To this are added the concentrations of the particular surfactants. Subsequently, the temperature is increased stepwise from 20 to 90° C., and the temperature window in which a microemulsion forms is observed.

The formation of the microemulsion can be assessed visually or else with the aid of conductivity measurements. A triphasic system forms (upper oil phase, middle microemulsion phase, lower water phase). When the upper and lower phase are of equal size and do not change over a period of 24 h, the optimal temperature (Tₒₚₜ) of the microemulsion has been found. The volume of the middle phase is determined. The volume of surfactant added is subtracted from this volume. The value obtained is then divided by two. This volume is then divided by the volume of surfactant added. The result is noted as SP*.

The type of oil and water used to determine SP* is determined according to the system to be studied. It is possible either to use mineral oil itself or a model oil, for example decane. The water used may either be pure water or saline water, in order better to model the conditions in the mineral oil formation. The composition of the aqueous phase can, for example, be adjusted according to the composition of a particular deposit water.

Alternatively, interfacial tensions of crude oil in the presence of surfactant solution can be determined at the respective temperature by the spinning drop method using an SVT20 from DataPhysics. For this purpose, an oil droplet is injected into a capillary filled with saline surfactant solution at the respective temperature and the expansion of the droplet at approx. 4500 revolutions per minute is observed until a constant value is established. This is typically the case after 2 h. The interfacial tension IFT (or s_{II}) is calculated—as described by Hans-Dieter Dörfler in “Grenzflächen and kolloid-disperse Systeme” Springer Verlag Berlin Heidelberg 2002—by the following formula from the cylinder diameter d_{z}, the speed of rotation w, and the density difference (d₁−d₂): s_{II}=0.25·d_{z}³·w2·(d₁−d₂)

### Test Results

A 1:1 mixture of decane and an NaCl solution is admixed with butyl diethylene glycol (BDG). Butyl diethylene glycol (BDG) functions as a cosolvent and is not included in the calculation of SP*. To this is added a surfactant mixture composed of alkyl alkoxysulfate and anionic surfactant. The total surfactant concentration is reported in percent by weight of the aqueous phase.

The results are shown in table 1.

TABLE 1
Experiments with decane

| | C16C18—7PO— | | | | | | |
|---|---|---|---|---|---|---|---|
| | SO₄Na^{a)}:anionic | Surfac- | BDG | NaCl | Tₒₚₜ | | IFT |
| Ex. | surfactant = 3:1 | tant [%] | [%] | [%] | [° C.] | SP* | [mN/m] |
| C1 | dodecylbenzene- | 5 | 4 | 4 | 62.5 | 14.75 | 0.0014 |
| | sulfonate | | | | | | |
| | sodium salt | | | | | | |
| C2 | C₁₅C₁₈-internal | 5 | 4 | 4 | 64 | 14.75 | 0.0014 |
| | olefinsulfonate | | | | | | |
| | sodium salt^{b)} | | | | | | |
| C3 | C₁₆C₁₈-alpha- | 5 | 4 | 6 | 64 | 15 | 0.0013 |
| | olefinsulfonate | | | | | | |
| | sodium salt^{c)} | | | | | | |
| C4 | dodecylbenzene- | 0.2 | 2 | 3.75 | 53.8 | 13.6 | 0.0016 |
| | sulfonate | | | | | | |
| | sodium salt | | | | | | |
| 5 | sodium salt of | 0.4 | 2 | 4.7 | 59.9 | 18.3 | 0.0009 |
| | secondary | | | | | | |
| | alkanesulfonate | | | | | | |
| | having 14 to 17 | | | | | | |
| | carbon atoms^{d)} | | | | | | |

^{a)}surfactants of the formula (II) where R³ = n-C₁₄H₂₉, n-C₁₆H₃₃, R⁴ = H, k = m = 7, o = 0, Y⁻ = SO₄⁻ and M⁺ = Na⁺
^{b)}Petrostep S2, surfactant mixture of olefinsulfonates prepared by sulfonation of alkenes with an internal double bond (C₁₅H₃₀, C₁₆H₃₂, C₁₇H₃₄ and C₁₈H₃₆) and subsequent neutralization with NaOH; the main product is unsaturated aliphatic sulfonates, the sulfonate group being distributed along the hydrocarbyl chain.
^{c)}Surfactant mixture of olefinsulfonates prepared by sulfonation of alkenes with a terminal double bond (C₁₆H₃₂ and C₁₈H₃₆) and subsequent neutralization with NaOH; the main product is unsaturated aliphatic sulfonates, the sulfonate group being bonded to the terminal carbon atom.
^{d)}Mixture of 4 surfactants of the general formula (I) with different numbers of carbon atoms, the proportion of surfactants of the formula (I) - based in each case on the R¹R²CH— radical having 14 carbon atoms, is 20-30 mol %, the proportion of surfactants of the formula (I) having 15 carbon atoms is 25-30 mol %, the proportion of surfactants of the formula (I) having 16 carbon atoms is 20-30 mol % and the proportion of surfactants of the formula (I) having 17 carbon atoms is mol % 10-20%, based in each case on all R¹R²CH— radicals in these 4 surfactants.

As in example 5, in the case of use of the claimed surfactant of the formula (I), it is possible to achieve an ultralow interfacial tension with respect to decane. In the comparative examples, the interfacial tension is always higher.

TABLE 2
Experiments with decane

| | C24C26C28- | | | | | | |
|---|---|---|---|---|---|---|---|
| | Guerbet-7BuO— | | | | | | |
| | 7 PO-10EO- | | | | | | |
| | SO4Na^{e)}:anionic | Surfac- | BDG | Salt | Tₒₚₜ | | IFT |
| Ex. | surfactant = 3:1 | tant [%] | [%] | [%] | [° C.] | SP* | [mN/m] |
| 6 | sodium salt of | 0.4 | 2 | 4% | 57 | 55.75 | 0.0001 |
| | secondary | | | NaCl | | | |
| | alkanesulfonate | | | | | | |
| | having 14 to 17 | | | | | | |
| | carbon atoms^{d)} | | | | | | |

^{e)}surfactants of the formula (II) where R³ = n-C₁₀H₂₁, n-C₁₂H₂₅, R⁴ = n-C₁₂H₂₅, n-C₁₄H₂₉, n = 7, m = 7, l = 10, o = 0, Y⁻ = SO₄⁻ and M⁺ = Na⁺
^{d)}Mixture of 4 surfactants of the general formula (I) with different numbers of carbon atoms, the proportion of surfactants of the formula (I) - based in each case on the R¹R²CH— radical having 14 carbon atoms, is 20-30 mol %, the proportion of surfactants of the formula (I) having 15 carbon atoms is 25-30 mol %, the proportion of surfactants of the formula (I) having 16 carbon atoms is 20-30 mol % and the proportion of surfactants of the formula (I) having 17 carbon atoms is mol % 10-20%, based in each case on all R¹R²CH— radicals in these 4 surfactants.

Example 6 shows that other surfactant combinations of surfactant of the formula (I) and formula (II) also give rise to ultralow interfacial tensions.

The following studies were additionally conducted using the example of a deposit containing heavy oil:
the crude oil has a gravity of about 16° API
the deposit temperature is approx. 20° C.
and the reservoir water has approx. 16 100 ppm TDS (total dissolved salt).

To a solution comprising 12 000 ppm NaCl and 4100 ppm NaHCO₃ were added Na₂CO₃, alkyl ether sulfate of the formula (II), butyl diethylene glycol and 0.07% Sokalan® PA 20 (polyacrylate sodium salt). These solutions were combined with claimed surfactants of the formula (I) and noninventive anionic surfactants, for example alkylbenzenesulfonates, internal olefinsulfonates or alcohol sulfate. As well as the solubility of the surfactants, the interfacial tension of the surfactant formulation with respect to the crude oil was measured. The total surfactant concentration and the amount of Na₂CO₃ are based on the active substance and are reported in percent by weight of the aqueous phase.

The experimental results are shown in the tables which follow.

TABLE 3
Experiments with crude oil

| | | | | | Solubility in |
|---|---|---|---|---|---|
| | | | | | the binary |
| | | | NaCl + | IFT at | system at |
| Ex. | Surfactant formulation | Na₂CO₃ | NaHCO₃ | 20° C. | 20° C. |
| C7 | 0.08% C₁₆C₁₈—7BuO—7PO-10EO- | 0.25% | 1.2% + | 0.0220 | clear |
| | sulfate^{f)}, 0.02% Petrostep S2 | | 0.41% | mN/m | |
| | (internal olefinsulfonate from | | | | |
| | Stepan)^{b)}, 0.1% butyl diethylene | | | | |
| | glycol, 0.07% Sokalan PA 20^{h)}, | | | | |
| | remainder saltwater; see columns 2 | | | | |
| | and 3 | | | | |
| 8 | 0.08% C₁₆C₁₈—7BuO—7PO-10EO- | 0.25% | 1.2% + | 0.0102 | clear |
| | sulfate^{f)}, 0.02% C14C17-secondary | | 0.41% | mN/m | |
| | alkanesulfonate sodium salt^{d)}, 0.1% | | | | |
| | butyl diethylene glycol, 0.07% | | | | |
| | Sokalan PA 20^{h)}, remainder | | | | |
| | saltwater; see columns 2 and 3 | | | | |
| 9 | 0.07% C₁₆C₁₈—7BuO—7PO-8EO- | 0.25% | 1.2% + | 0.0070 | clear |
| | sulfate^{g)}, 0.03% C14C17-secondary | | 0.41% | mN/m | |
| | alkanesulfonate sodium salt^{d)}, 0.1% | | | | |
| | butyl diethylene glycol, 0.07% | | | | |
| | Sokalan PA 20^{h)}, remainder | | | | |
| | saltwater; see columns 2 and 3 | | | | |

^{f)}surfactants of the formula (II) where R³ = n-C₁₄H₂₉, n-C₁₆H₃₃, R⁴ = H, n = 7, m = 7, I = 10, o = 0, Y⁻ = SO₄⁻ and M⁺ = Na⁺
^{g)}surfactants of the formula (II) where R³ = n-C₁₄H₂₉, n-C₁₆H₃₃, R⁴ = H, n = 7, m = 7, I = 8, o = 0, Y⁻ = SO₄⁻and M⁺ = Na⁺
^{b)}Petrostep S2, surfactant mixture of olefinsulfonates prepared by sulfonation of alkenes with an internal double bond (C₁₅H₃₀, C₁₆H₃₂, C₁₇H₃₄ and C₁₈H₃₆) and subsequent neutralization with NaOH; the main product is unsaturated aliphatic sulfonates, the sulfonate group being distributed along the hydrocarbyl chain.
^{d)}Mixture of 4 surfactants of the general formula (I) with different numbers of carbon atoms, the proportion of surfactants of the formula (I) - based in each case on the R¹R²CH— radical having 14 carbon atoms, is 20-30 mol %, the proportion of surfactants of the formula (I) having 15 carbon atoms is 25-30 mol %, the proportion of surfactants of the formula (I) having 16 carbon atoms is 20-30 mol % and the proportion of surfactants of the formula (I) having 17 carbon atoms is mol % 10-20%, based in each case on all R¹R²CH— radicals in these 4 surfactants.
^{h)}polyacrylic acid sodium salt

As can be seen from examples 8 and 9, it is also possible in a difficult crude oil (API gravity below 20°), with the aid of the claimed surfactants, to achieve a low interfacial tension better by a factor of 2 to 3 than in comparative example C7. The surfactant solution is clear and allows problem-free injection into a porous rock of suitable permeability.

TABLE 4
Experiments with crude oil

| | | | | | Solubility in |
|---|---|---|---|---|---|
| | | | | | the binary |
| | | | NaCl + | IFT at | system at |
| Ex. | Surfactant formulation | Na₂CO₃ | NaHCO₃ | 20° C. | 20° C. |
| C10 | 0.07% C₃₂C₃₄C₃₆-Guerbet-7BuO—7PO- | 0.25% | 1.2% + | 0.2023 | clear |
| | 10EO-sulfateⁱ⁾, 0.03% sodium | | 0.41% | mN/m | |
| | dodecylsulfate, 0.1% butyl | | | | |
| | diethylene glycol, 0.07% Sokalan PA | | | | |
| | 20 ^{h)}, remainder saltwater; see | | | | |
| | columns 2 and 3 | | | | |
| 11 | 0.07% C₃₂C₃₄C₃₆-Guerbet-7BuO—7PO- | 0.25% | 1.2% + | 0.0653 | clear |
| | 10EO-sulfateⁱ⁾, 0.03% C14C17- | | 0.41% | mN/m | |
| | secondary alkanesulfonate sodium | | | | |
| | salt^{d)}, 0.1% butyl diethylene glycol, | | | | |
| | 0.07% Sokalan PA 20 ^{h)}, remainder | | | | |
| | saltwater; see columns 2 and 3 | | | | |

ⁱ⁾surfactants of the formula (II) where R³ = n-C₁₄H₂₉, n-C₁₆H₃₃, R = n-C₁₆H₃₃, n-C₁₈H₃₇, n = 7, m = 7, I = 10, o = 0, Y⁻ = SO₄⁻ and M⁺ = Na⁺
^{d)}Mixture of 4 surfactants of the general formula (I) with different numbers of carbon atoms, the proportion of surfactants of the formula (I) - based in each case on the R¹R²CH— radical having 14 carbon atoms, is 20-30 mol %, the proportion of surfactants of the formula (I) having 15 carbon atoms is 25-30 mol %, the proportion of surfactants of the formula (I) having 16 carbon atoms is 20-30 mol % and the proportion of surfactants of the formula (I) having 17 carbon atoms is mol % 10-20%, based in each case on all R¹R²CH— radicals in these 4 surfactants.
^{h)} polyacrylic acid sodium salt

As can be seen from example 11, it is also possible in a difficult crude oil (API gravity below 20°), with the aid of the claimed surfactants, to achieve a low interfacial tension better by a factor of 3 than in comparative example 010. The surfactant solution is clear and allows problem-free injection into a porous rock of suitable permeability.

TABLE 5
Experiments with light oil under high salinity

| | | | | | Solubility |
|---|---|---|---|---|---|
| | | | | | in binary |
| | | | | IFT at | system at |
| Ex. | Surfactant formulation | NaCl | CaCl₂ | 40° C. | 40° C. |
| 12 | 0.07% C₁₆C₁₈—3PO- | 13.5% | 1.5% | 0.0076 | slightly |
| | 10EO-CH₂CO₂Na, 0.03% | | | mN/m | scattering |
| | C14C17-secondary | | | | |
| | alkane sulfonate | | | | |

As shown in example 12 of table 5, a low interfacial tension of 0.007 mN/m against light crude oil (API 33°) can be realized using claimed surfactants even under high salinity (150000 ppm TDS). Surfactant solution is very slightly scattering and can be injected in a porous rock with suitable permeability.

1. A process for producing mineral oil by means of Winsor type III microemulsion flooding, said process comprising
injecting through at least one injection well into a mineral oil deposit an aqueous surfactant formulation comprising a surfactant mixture, for the purpose of lowering the interfacial tension between oil and water to <0.1 mN/m,
and withdrawing crude oil through at least one production well from the deposit,
wherein the surfactant mixture comprises at least one secondary alkanesulfonate of general formula (I) 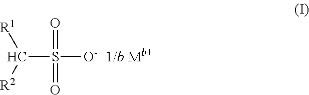
and at least one anionic surfactant of general formula (II) 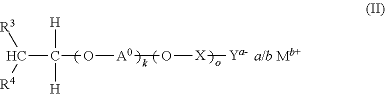
where
R¹ and R² are each independently a linear or branched, saturated aliphatic hydrocarbyl radical, where the R¹CHR² radical has 14 to 17 carbon atoms;
R³ is a linear or branched, saturated or unsaturated aliphatic hydrocarbyl radical and
R⁴ is H or a linear or branched, saturated or unsaturated aliphatic hydrocarbyl radical, where the R³R⁴CHCH₂ radical has 8 to 44 carbon atoms;
each A⁰ is independently ethylene, propylene or butylene;
k is an integer from 1 to 99,
X is a branched or unbranched alkylene group which has 1 to 10 carbon atoms and is optionally substituted by an OH group;
o is 0 or 1;
each M^{b+} is independently a cation with charge b;
Y^{a-} is a sulfate group, sulfonate group, carboxylate group or phosphate group;
b is 1, 2 or 3 and
a is 1 or 2.

2. The process according to claim 1, wherein
R³ is a linear, saturated or unsaturated aliphatic hydrocarbyl radical having 14 to 16 carbon atoms, and
R⁴ is a hydrogen atom.

3. The process according to claim 1, wherein
R³ is a linear, saturated or unsaturated aliphatic hydrocarbyl radical having 10 or 12 carbon atoms, and
R⁴ is a linear, saturated or unsaturated aliphatic hydrocarbyl radical having 12 or 14 carbon atoms.

4. The process according to claim 1, wherein
R³ is a linear, saturated or unsaturated aliphatic hydrocarbyl radical having 14 or 16 carbon atoms, and
R⁴ is a linear, saturated or unsaturated aliphatic hydrocarbyl radical having 16 or 18 carbon atoms.

5. The process according to claim 1, wherein k in general formula (II) is an integer in the range from 4 to 50.

6. The process according to claim 1, wherein (OA⁰)ₖ in general formula (II) represents n butyleneoxy, m propyleneoxy and 1 ethyleneoxy groups, where n+m+l=k.

7. The process according to claim 6, wherein at least some of the n butyleneoxy, m propyleneoxy and 1 ethyleneoxy groups are arranged in blocks.

8. The process according to claim 6, wherein the (R³)(R⁴)—CH—CH₂— radical in general formula (II) is followed, representing (OA⁰)ₖ, by a butyleneoxy block with n butyleneoxy groups, followed by a propyleneoxy block with m propyleneoxy groups, and finally an ethyleneoxy block with 1 ethyleneoxy groups.

9. The process according to claim 6, wherein m is an integer from 4 to 15 and 1 is an integer from 0 to 25 and n is 0.

10. The process according to claim 6, wherein m is an integer from 4 to 15 and 1 is an integer from 0 to 25 and n is an integer from 1 to 15.

11. The process according to claim 1, wherein the (OX)ₒY^{a-} radical in general formula (II) is OS(O)₂O⁻, OCH₂CH₂S(O)₂O⁻, OCH₂CH(OH)CH₂S(O)₂O⁻, O(CH₂)₃S(O)₂O⁻, S(O)₂O⁻, CH₂C(O)O⁻ or CH₂CH(R′)C(O)O⁻, where R′ is hydrogen or an alkyl radical having 1 to 4 carbon atoms.

12. The process according to claim 1, wherein the aqueous surfactant formulation comprises, in addition to the surfactant mixture, also at least one cosolvent selected from the group consisting of butyl monoethylene glycol, butyl diethylene glycol, butyl triethylene glycol, n-propanol, isopropanol, n-butanol, isobutanol, sec-butanol, n-pentanol and isopentanol.

13. The process according to claim 1, wherein the aqueous surfactant formulation comprises, in addition to the surfactant mixture, also at least one basic salt selected from the group consisting of sodium carbonate, sodium hydrogencarbonate, sodium hydroxide, potassium hydroxide and silicates.

14. The process according to claim 1, wherein the aqueous surfactant formulation comprises, in addition to the surfactant mixture, also at least one chelating agent.

15. The surfactant mixture as specified in claim 1.

16. The aqueous surfactant formulation as specified in claim 1.
